(19) United States
(12) Patent Application Publication
(10) Pub. No.: US 2006/0262640 A1
(43) Pub. Date: Nov. 23, 2006

(54) MIXING HEAD WITH INTEGRATED SHOT COUNTER

(75) Inventors: Ernst Berchtenbreiter, Kissing (DE); Wolfgang Sochtig, Germering (DE)

Correspondence Address: HENRY M FEIEREISEN, LLC, 350 FIFTH AVENUE, SUITE 4714, NEW YORK, NY, 10118, US

(73) Assignee: Krauss-Maffei Kunststofftechnik GmbH, Munchen (DE)

(21) Appl. No.: 11/383,040

(22) Filed: May 12, 2006

(30) Foreign Application Priority Data
May 20, 2005 (DE) 10 2005 023 232.9

(51) Int. Cl. B29B 7/76

(52) U.S. Cl. 366/162.5

(57) ABSTRACT

A mixing head includes an integrated shot counting apparatus. The shot counting apparatus is hereby implemented as an integrated circuit with a detector for ascertaining an operating parameter of the mixing head, and an electric acquisition and storage unit operatively connected to the detector and having a counter and a non-volatile memory device which is operatively connected to the counter.

### CROSS-REFERENCES TO RELATED APPLICATIONS

This application claims the priority of German Patent Application, Serial No. 10 2005 023 232.9, filed May 20, 2005, pursuant to 35 U.S.C. 119(a)-(d), the content of which is incorporated herein by reference.

### BACKGROUND OF THE INVENTION

The present invention relates to a mixing head with integrated shot counter.

Nothing in the following discussion of the state of the art is to be construed as an admission of prior art.

In mixing heads used for example in the processing of polyurethane, the number of material discharges, also called “shots” and typically corresponding the number of articles being produced, is ascertained. The warranty for a mixing head normally covers the number of such shots. To date, the number of shots executed by a mixing head is acquired by counting the opening and closing operations of the mixing head, for example by monitoring the operation of a control and/or cleaning piston. The respective information is then transmitted to an external controller. A counter in the external controller determines the total number of shots for a mixing head and the information is stored in a memory. A drawback of this configuration is the absence of a direct correlation between the count determined by the counter and the mixing head. This poses a problem in particular when a customer intends to replace a mixing head, because the customer needs to ascertain the actual count in the external controller and to associate it to the removed mixing head. Only then can the customer, based on the number of shots, find out the actual load the mixing head is subjected. This means that in a situation when a warranty is still effective, the manufacturer of such mixing heads needs to rely on the honesty and trustworthiness of the customer. But even when the customer is known to be trustworthy, there is still the problem that the extent of usage, i.e. number of shots, cannot always be reliably correlated to the used mixing head.

It would therefore be desirable and advantageous to provide an improved mixing head to obviate prior art shortcomings.

### SUMMARY OF THE INVENTION

According to one aspect of the present invention, a mixing head includes a shot counting apparatus which has a detector for ascertaining an operating parameter of the mixing head, and an electric acquisition and storage unit operatively connected to the detector and having a counter and a non-volatile memory device which is operatively connected to the counter.

The present invention resolves prior art problems by integrating the counter and the non-volatile memory device of the electric acquisition and storage unit within the structure of the mixing head. The counter of the electric acquisition and storage unit counts the shots and stores them in the memory device or other suitable data recordation medium. Suitably, the movement of a control and/or cleaning piston of the mixing head is detected by the detector and used as operating parameter. The detector may hereby be implemented as a sensor, e.g. a switch such as a reed switch. Suitably, the switch can be disposed in a cylinder cover of the mixing head, or in a housing of the control and/or cleaning piston. Other examples for used operating parameter of the mixing head may include current consumption, voltage use, or a pressure parameter for the mixing head so that the detector generates a corresponding electric or hydraulic signal. In this case the detector may be implemented as a current sensor, voltage sensor, or pressure sensor. Of course, other operating parameters may be conceivable as well.

According to another feature of the present invention, the counter may be an incremental counter.

According to another feature of the present invention, an interface may be provided for realizing a communication connection to the electric acquisition and storage unit. In this way, information or data from the electric acquisition and storage unit can be retrieved. To prevent manipulation, the memory device of the electric acquisition and storage unit may be constructed as a read-only memory device (read-only counter). This prevents writing or overwriting of storage content.

According to another feature of the present invention, a battery may be provided for supply of electric energy to the electric acquisition and storage unit and/or buffering the memory device. In this way, a continuous operation of the electric acquisition and storage unit is ensured. The use of a lithium battery for example enables a buffering over a time period of up to 30 years.

According to another feature of the present invention, the mixing head has a housing in which the electric acquisition and storage unit may be firmly integrated in the housing, e.g. through casting, e.g. in a cylinder cover of the mixing head upon the control and/or cleaning piston. As a result, the electric acquisition and storage unit cannot not be removed without damage, thereby essentially thwarting any possibility of manipulation. To further enhance this security feature, the memory device of the electric acquisition and storage unit may store a uniquely identifiable information about the mixing head. This uniquely identifiable information may hereby be non-erasably stored in the memory device. It may also be possible to have an identification number issued by the manufacturer burnt into the counter. Storage of additional information in the memory device or in an additional memory device may also be conceivable. For example, such an additional memory device may store short text information about the track record of the mixing head, such as data about repair and associated counts. In this way, the overall history of the mixing head can be continuously documented.

A mixing head according to the present invention can thus be easily monitored as far as usage is concerned. Possibility of any manipulations can thus be essentially precluded in view of the unambiguous association between extent of usage and mixing head. Unauthorized exchange of a mixing head is prevented as the identification number would no longer match a serial number of a mixing head.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic plan view of a cylinder cover of a mixing head according to the present invention; and

FIG. 2 is a schematic sectional view of the cylinder cover, taken along the line A-A in FIG. 1.

### DETAILED DESCRIPTION OF PREFERRED EMBODIMENTS

Throughout all the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

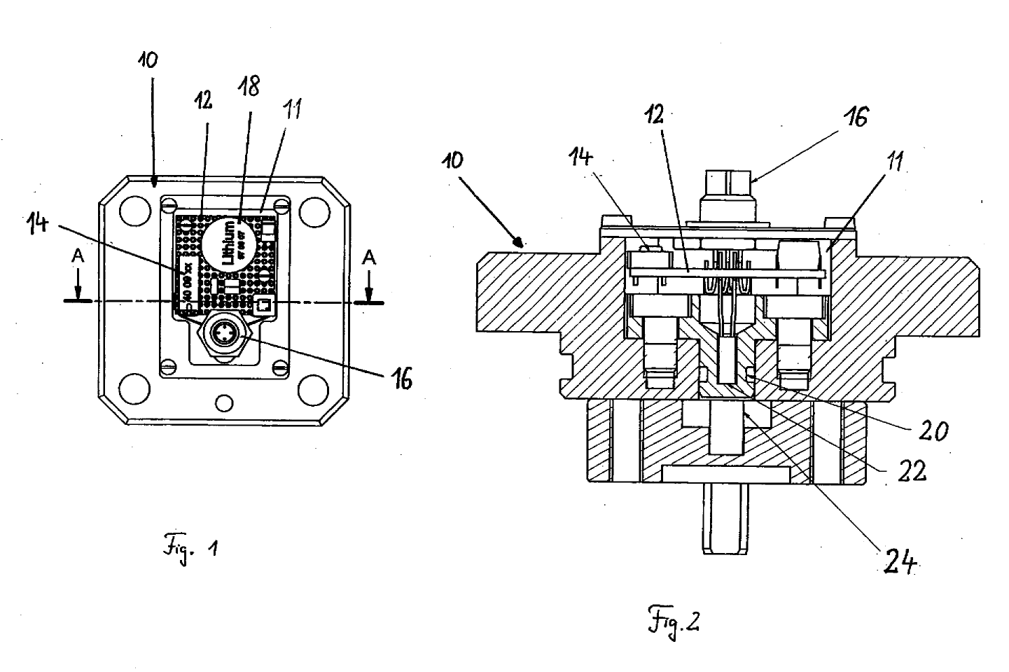

Turning now to the drawing, and in particular to FIG. 1, there is shown a schematic plan view of a cylinder cover, generally designated by reference numeral 10 and forming part of a mixing head according to the present invention. Although not shown in detail, the mixing head has integrated therein a control and/or cleaning piston which can be displaced by a hydraulic unit. Operation and structure of a control and/or cleaning piston are generally known to the artisan so that a further detailed description is omitted for the sake of simplicity. The control and/or cleaning piston as well as other necessary components of the mixing head have not been shown or described in detail for the sake of simplicity as they do not form part of the present invention.

The cylinder cover 10 includes a top recess 11 for receiving a printed circuit board 12 which has an electronic acquisition and storage unit in the form of an integrated circuit chip (IC) 14 with a counter and a non-volatile memory device interconnected to one another. Electric energy is supplied to the printed circuit board 12 by a battery 18, e.g. a lithium battery that has a life span of about 30 years. The printed circuit board 12 is fitted non-detachably in the top recess 11 through a casting process and connected via wire contacts to a separate socket connector 16 which serves as interface to an external controller (not shown), by which the overall operation of the mixing head is controlled. The controller can thus be operatively connected via the interface to the electronic acquisition and storage unit.

As shown in FIG. 2, the printed circuit board 12 is further provided with a detector which includes a sensor 22 in the form of a switch such as a reed switch. The sensor 22 is disposed in a dip tube 20 and interacts with a magnet 24 disposed below the sensor 22. The dip tube 20 is hereby directed in the direction of the control and/or cleaning piston.

In the assembled state of the mixing head, the cylinder cover 10 is placed upon a housing of the control and/or cleaning piston. Although not shown in detail, the housing of the control and/or cleaning piston would be disposed at the lower end in the illustration of FIG. 2 and may be part of a housing of the mixing head.

Operation of the hydraulic unit causes the control and/or cleaning piston to move between upper and lower positions. In the lower position, the mixing head is closed so that no discharge occurs. In the upper position, the mixing head is open to execute a discharge. As a result, a movement from the lower position to the upper position indicates a shot, i.e. material discharge. The movement of the control and/or cleaning piston and thus the initiation of a shot is detected by the sensor 22 which generates a respective signal for transmission to the integrated circuit 14. The counter integrated in the integrated circuit 14 increases the shot number after each shot by 1 and stores the value in the integrated memory device.

The memory device of the integrated circuit 14 also includes a 64-bit identification number which allows a distinct association of the counter to a serial number of the mixing head.

In view of the autarkic supply of electric energy to the integrated circuit 14 by the lithium battery 18, the acquisition and storage unit with its shot counter and memory device can be integrated within the mechanics of the mixing head. The memory device is suitably constructed as read-only memory.

Of course, the socket connector 16 may also be configured to transmit a shot signal to an external controller for subsequent processing. In any event, each count impulse is processed in the integrated circuit 14 and directly associated to the mixing head. When a mixing head needs repair, the count can be retrieved via an interface, for example a serial interface, so as to ascertain the extent of usage of the mixing head.

The memory device of the integrated circuit 14 is constructed to have a storage area for allowing storage of short text files. These text files can be used to contain information about the history of the mixing head, such as data of individual repairs and associated counts. Thus, the history of the mixing head can be chronicled without gaps. By enabling a precise determination of the track record of a mixing head according to the present invention, manipulations can be precluded because it requires alteration of the casting compound so that any warranty would be voided. Unauthorized exchange of the cylinder cover is also not possible because the identification number will then no longer match the serial number of a mixing head.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A mixing head having integrated therein a shot counting apparatus, said shot counting apparatus comprising a detector for ascertaining an operating parameter of the mixing head, and an electric acquisition and storage unit operatively connected to the detector and having a counter and a non-volatile memory device which is operatively connected to the counter.

2. The mixing head of claim 1, further comprising a control and/or cleaning piston, wherein the operating parameter is a movement or actuation of the control and/or cleaning piston.

3. The mixing head of claim 1, wherein the detector is an integral part of the electric acquisition and storage unit.

4. The mixing head of claim 1, wherein the counter is an incremental counter.

5. The mixing head of claim 1, wherein the detector includes a sensor.

6. The mixing head of claim 5, wherein the sensor is a switch.

7. The mixing head of claim 6, wherein the switch is a reed switch.

8. The mixing head of claim 1, further comprising an interface for providing a communication connection to the electric acquisition and storage unit.

9. The mixing head of claim 1, wherein the memory device of the electric acquisition and storage unit is a read-only memory device (read-only counter).

10. The mixing head of claim 1, further comprising a battery for providing electric energy to the electric acquisition and storage unit and/or buffering of the memory device.

11. The mixing head of claim 1, further comprising a housing, said electric acquisition and storage unit being integrated in the housing.

12. The mixing head of claim 11, wherein the electric acquisition and storage unit is cast into the housing.

13. The mixing head of claim 2, wherein the control and/or cleaning piston has a housing, said electric acquisition and storage unit being integrated in the housing.

14. The mixing head of claim 13, wherein the control and/or cleaning piston has a cylinder cover for placement upon the housing of the control or cleaning piston, said electric acquisition and storage unit being integrated in the cylinder cover.

15. The mixing head of claim 14, wherein the electric acquisition and storage unit is cast into the cylinder cover.

16. The mixing head of claim 1, wherein the memory device of the electric acquisition and storage unit stores a uniquely identifiable information about the mixing head in a first storage area.

17. The mixing head of claim 16, wherein the uniquely identifiable information is non-erasably stored in the memory device.

18. The mixing head of claim 1, wherein the electric acquisition and storage unit includes a further memory device for storage of additional data.

19. The mixing head of claim 16, wherein the memory device has a second storage area for storage of additional data.

20. A mixing head, comprising:
a housing having a mixing chamber with an outlet for discharge of a reaction mixture;
a control and/or cleaning piston received in the housing for movement between a retracted lower position away from the outlet and an upper position in which a shot amount of the reaction mixture is discharged from the mixing chamber through the outlet;
a cover for placement onto the housing; and
a shot counting apparatus for determining a number of shots, said shot counting apparatus including
a detector integrated in the cover and rendered operative in response to a movement of the control and/or cleaning piston from the lower position to the upper position to generate a signal,
a counter receiving the signal from the detector and increasing the number of shots by 1 in response to the signal of the detector, and
a non-volatile memory for storing the number of shots.

21. The mixing head of claim 20, wherein the shot counting apparatus includes a printed circuit board, received in a recess of the cover, and an integrated circuit deposited on the printed circuit board and including the counter and the memory device.

22. The mixing head of claim 21, wherein the shot counting apparatus includes an interface for connection of a controller and connection of the controller to the integrated circuit.
